(19) United States
(12) Patent Application Publication
(10) Pub. No.: US 2014/0205113 A1
(43) Pub. Date: Jul. 24, 2014

(54) EXPRESSION-ENABLED AUDIO SIGNAL PROCESSING PLATFORM

(71) Applicant: Stomp Labs Inc., Sydney (CA)

(72) Inventors: Jeffrey Alan Slipp, Sydney (CA); Cecil Todd Smith, Dominion (CA)

(73) Assignee: Stomp Labs Inc., Sydney (CA)

(21) Appl. No.: 14/157,930

(22) Filed: Jan. 17, 2014

Related U.S. Application Data
(60) Provisional application No. 61/754,047, filed on Jan. 18, 2013.

(51) Int. Cl. G10H 7/00

(52) U.S. Cl. CPC G10H 7/008
USPC 381/119

(57) ABSTRACT

Our device relates to an audio signal processing device, a means for sharing expression control signals between physically separate sound processing devices, a method of deriving related expression control signals from a common expression control signal, and a means for mapping control signals from an expression device to one or more of the various control parameters of the audio signal processing device.

### TECHNICAL FIELD OF THE INVENTION

Our device relates in general to audio signal-processing devices such as those used in the music industry to modify the audio tone so as to make it more interesting to the listener. Such audio signal processing devices include, but are not limited to, effects pedals, multi-effects floor processors, rack-mount processors, equalizers, and amplifiers.

### BACKGROUND

The following is a tabulation of some prior art that presently appears relevant:

U.S. Patents

| Patent Number | Kind Code | Issue Date | Patentee |
|---|---|---|---|
| 5,961,862 | | Nov. 9, 1999 | William H. Geier Jr. |
| 7,709,726 B2 | | Oct. 26, 2010 | Robling, et. al |
| 8,084,681 B2 | | Dec. 27, 2011 | Neil Schon |

U.S. Patent Application Publications

| | | | |
|---|---|---|---|
| Patent Number | Kind Code | Pub. Date | Applicant |

Foreign Patent Documents

| | Country | Kind | | |
|---|---|---|---|---|
| Foreign Doc. Nr. | Code | Code | Pub. Date | App or Patentee |
| WO 2009/012533 A1 | AU | | Jan. 29, 2009 | VFX Systems Pty. |
| | | | | Ltd. |

### Non-Patent Literature Documents

Boss GT-10:
   http://www.bossus.com/gear/productdetails.php?ProductId=941
Tone In Progress Third Hand:
   http://www.bananasmusic.com/productdetail/asp/pid_{—}9622/productname_Tone-In-Progress-3rd-Hand
Electro-Harmonix Expression Pedal: http://www.ehx.com/products/expression-pedal
Pigtronix Dual Expression Pedal: http://www.pigtronix.com/products/dual-expression-pedal/
VOX Amplification DelayLab: http://www.voxamps.com/pedals/delaylab/
VOX Amplification StompLab: http://www.voxamps.com/pedals/stomplab
Diamond Pedals Halo Chorus: http://www.diamondpedals.com/products/halo.html
Diamond Pedals Phase: http://www.diamondpedals.com/products/phase.html
Diamond Pedals Vibrato: http://www.diamondpedals.com/products/vibrato.html
Boomerang Pedals: http://www.boomergmusic.com/E155.shtml
Option Knob: http://www.optionknob.com/

It is well known in the music industry that electronic means are used to process audio signals. This processing is applied to guitar, bass keyboards, bass, and microphone signals. Audio signal-processing devices are used to modify an audio signal, for the purpose of making the tone more interesting to the listener. These audio signal-processing devices include, but are not limited to, effect pedals, multi-effects floor processors, rackmount processors, amplifiers, filters, and equalizers. Each audio signal-processing device has a number of control parameters used to shape the tone of the audio signal. These control parameters appears as knobs, sliders, buttons and switches on the control panel of the audio signal-processing devices. It is also well established that musicians desire the ability to manipulate these control parameters during a performance to add a degree of expression that makes the tone more interesting and serves to differentiate the musician. However, as with most musicians such as a guitarist, both hands are engaged in playing the instrument, one hand fretting the notes and the other hand plucking the strings. As such the hands are not available to manipulate these controls during performances. Their feet, not being used for anything other than standing on or moving around stage, are available for simple maneuvers that can be easily be integrated into the standing operation. For example the feet can be used to engage a switch or rotate a pedal. For this reason the music industry makes use of foot-operated expression pedals to manipulate these controls. These foot-operated expression pedals are typically a treadle style device, with a pedal that rotates about an axis, and provides an output that is directly proportional to the angular displacement of the pedal. The more the pedal is rotated the larger the expression signal. The expression pedal is coupled to the effects pedal via a cable. Commonly available expression pedals include the Roland EV-5 or the Korg EXP2. On audio signal-processing devices that are equipped with an expression input, the artist can easily manipulate control parameters with his foot during live performances.

Expression control is typically found on effects devices, but there is no reason that it couldn't also be provided on amplifiers, filters, and equalizers. However, for the purpose of this Illustration we will consider only effects devices since they are the devices that traditionally have expression inputs.

Effects devices come in three major categories: “effect pedals”, also know as “stomp boxes”, “multi-effects floor processors” and “rack-mount processors”. An effect pedal includes only one major type of effect such as distortion or chorus or reverb, etc. A multi-effects floor processor, or simply a multi-effects device, includes two or more effects. Examples include such items as a Boss GT-10, TC Electronics G-System, or a Line 6 POD X3 Live. Rack-mount processors are similar to multi-effects floor processors and also include two or more effects. However, rack-mount processors are mounted in a rack, usually behind the stage. Typical effects include, but are not limited to, fuzz, distortion, chorus, phaser, flanger, delay, echo, reverb, wah-wah, noise gate, compressor. These effects devices incorporate electronics, either analog or digital, to create the desired effect. The musical instruments typically used with an effects pedal include guitar, bass, keyboards, but may include other instruments as well, including voice and other instruments captured with a microphone.

Effects devices include at least one foot-operated switch that allows the effect be turned on and off, and some include several foot-operated switches offering control over other parameters. Effects pedals also include a number of controls, such as buttons, knobs, switches, etc. that provide the user with a degree of control over the tone produced.

An electric guitar player, hereinafter referred to as the artist, typically has a number of effects pedals connected in serial fashion with the output of one audio processing device connected to the input of the next device. Such a configuration will hereinafter be referred to as an “effects chain”.

It is well known in the music industry that single-effects pedals are easier to use as each device is independent of the others, possessing its own user interface. For example each single-effects pedal includes dedicated knobs, switches, button, for the various parameters for that device and light indicators and displays for visual feedback. While playing, it is very easy for the artist to identify the control that is to be manipulated to produce a desired tone and hence requires little time for the artist to change tones. This is very efficient when playing live performances and many artists prefer these devices for that reason. Correspondingly it is well known in the music industry that multi-effects devices and rack-mount processors are more difficult to operate, primarily because a single user interface is shared amongst several effects. For example there is typically one set of controls, consisting of knobs, switches and buttons, a number of light indicators, and one visual display that is used to control any of the available effects. The artist must navigate a number of user interface screens on the visual display to access the desired effect. Furthermore the artist must visually map the physical controls to the current user interface screen. This makes it more difficult for the artist to learn the user interface and time consuming to changes control parameters to achieve the desired sound. This is not efficient for playing live performances. Hence multi-effects devices are typically used in the studio where the artist has sufficient time to configure parameters between takes. Multi-effects devices are also used by guitar enthusiasts as a cost effective means of accessing a variety of effects. Rack-mount processors are also used in the studio and on stage but are typically operated by a dedicated technician while the artist is performing.

One of the earliest expression pedals for effects pedals was introduced by Electro-Harmonix. The Hot Foot was a mechanical device consisting of a treadle pedal, gear assembly and flexible cable with attached mechanical adapter that permits connection to a control knob. As the pedal is rotated the motion is translated through the gear assembly and flexible cable to the control knob. This allowed the knob to be rotated as the pedal is rotated. The Hot Foot concept was briefly re-introduced by Tone In Progress' Third Hand that operates in an identical manner. The limitations of this device are many: it can be attached to only one control parameter at a time; there is no ability to link to downstream devices; it is not practical to change connections during live performances; there is always a one-to-one correspondence between treadle position and control parameter setting; the cable length is limited, making it necessary to physically place the controller close to the device being controlled; there is very limited ability to set the minimum and maximum positions (which can only be accomplished by carefully prepositioning the control parameter shaft and pedal position prior to mechanically connecting the cable); the mechanical forces transferred through the cable require that both devices are securely fastened down; finally the control parameter to which the cable is connected is subjected to excessive force as the rotation of the shaft may hit a hard limit before the pedal reaches its limit, which may result in premature failure of the control parameter.

Several attempts have been made to create alternate mappings of the expression signal available from the expression pedal itself. However, this approach is fundamentally limited as it still produces a single expression signal per electrical connection. Electro-Harmonix has developed the Expression Pedal that does include the ability to generate direct linear or inverse linear expression signal. Selection is via a mechanical switch that must be manipulated each time the expression signal is to be altered. However this arrangement has several limitations. First and foremost it can generate only one signal at a time. It is not possible to simultaneously manipulate controlled parameters in opposite directions. Pigtronix's Dual Expression Pedal improves upon the Electro-Harmonix pedal by providing two expression signal outputs. Output one (1) is a direct linear output signal while output two (2) can be configured as either a direct linear or inverse linear expression signal. Configuration of output two (2) is by way of mechanical polarity reversal switch. In this way both signals can be implemented at the same time. The limitation with this arrangement is that the two signals cannot be fed to one effects pedal as effects pedals only have one expression signal input. In practice one signal would be fed to one effects pedal while the second signal would be fed to another effects pedal. This eliminates the possibility of controlling two control parameters in opposite directions.

The Option Knob (U.S. Pat. No. 7,709,726) is a mechanical device that attempts to fill the need for artists to implement real-time expression control. This device is essentially a mechanical knob with enlarged wings that can be manipulated by foot during play. Similar to the Hot Foot its drawbacks are that it can only be attached to one control parameter at a time, and it cannot be changed practically during a live performance. Due to the physical size of the device only one can be used on a given effects pedal at any one time. This device requires a degree of dexterity that greatly exceeds that of foot-operated pedal. Furthermore, it does not facilitate smooth and rapid transitions in the way that a pedal can due to the transition process as the foot must at some point move around the wings, which are 180 degrees apart to continue movement of the full 270 degrees that is the range of most rotary controls.

Some single-effect pedals include expression pedal inputs. For example, U.S. Pat. No. 5,981,862 describes a guitar effects pedal that effectively includes an Integrated expression control via a foot-operated overdrive control dial. This patent describes an invention that enables the user to control the overdrive, or distortion level, by using their foot to manipulate a dial mechanically connected to a potentiometer that sets the overdrive. The limitations of this device are: it permits foot control over only one control parameter and can't be remapped to other controls, the expression signal is not available to any downstream devices, and the manipulation of a dial by foot requires more dexterity than using a rotating pedal.

U.S. Pat. No. 8,084,681 describes an effects pedal with integrated expression pedal. In this case the effect is a combined distortion and amplification pedal with the expression pedal controlling the degree of distortion and amplification. The drawbacks of this particular device are: the expression signal is not available to downstream effects pedals; the expression pedal always controls the same control parameters, the control parameters are always directly proportional to the pedal rotation, there are no alternative expression mappings.

WO 20091012533 A1 describes an effects pedal that accepts down-loadable plug ins and also includes a pedal. Presumably the pedal is used for Wah-wah and volume pedal type plug-ins. This item does not include a signal output to share the pedal signal with downstream devices, the patent makes no mention of mapping of the pedal encoder to more than one parameters, and it does not provide alternate mappings of the pedal signal.

Other commercially available effects pedals that incorporate expression control include Diamond Pedals' “Diamond Halo Chorus” and “Diamond Phase”. However, serious limitations of these devices include the fact that the expression signal is tied to a single control parameter. In both of the above referenced devices the expression pedal is tied to the Local Frequency Oscillator (LFO). Furthermore there is the requirement for a dedicated expression device for each single-effect unit due to a single expression pedal input and the inability to share expression signals. Diamond Pedals also offers the “Diamond Vibrato” which does provide expression control over two parameters, depth and speed. However it accomplishes this using two independent expression jacks, one for each control parameter. This requires two expression pedals. Finally all of the Diamond pedals do not provide the ability to easily switch between expression control and knob control. To accomplish this the user must unplug the respective expression pedal. This is quite impractical during live performances. All Diamond Pedals products lack the connector jacks that support downstream linking of the devices' expression signals. These pedals are further limited in that the signal is connected to one tone control and there is no ability to switch it between tone controls. Finally there is only one mapping of the control: it is directly proportion to pedal rotation.

Boomerang Musical Products provides the “E-155 Delay” and “III Phrase Sampler”. These products do include an expression pedal input and permits mapping of the expression pedal to one or more control parameters. It also includes a proprietary communications technology that permits the linking of Boomerang Musical Instruments Products. However neither device includes an expression signal output jack to enable sharing of the expression signal with downstream effects pedals. Its' communications technology is used to share and recall presets. Finally, it also does not support alternate mappings of the expression signal.

VOX Amplification has two products of interest with expression control: StompLab and DelayLab, both of which allow expression signal mapping to selected control parameters. It is important to note that only certain pre-determined control parameters can be selected for expression control. DelayLab is for delay effects only and does not include an integrated effect pedal. StompLab includes multiple effects and does include an integrated expression pedal. Neither DelayLab or StompLab support expression control of multiple control parameters simultaneously, alternate mappings of the expression signal, nor expression signal output to allow downstream chaining of the expression signal.

Multi-effects pedals typically include an expression pedal input, and some include two (2) inputs. This expression pedal input can be mapped to one of numerous control parameters that exist within the multi-effects unit. For example it could be mapped to the volume on a distortion pedal or the speed on a phaser at the artist's discretion. Mapping is accomplished through a graphical user interface. The user must navigate a number of user interface displays to switch between the virtual effects pedals and select the control to be mapped. Multi-effects however, do suffer several drawbacks they do not include the ability to map the expression signal to more than one control parameter at a time, they lack a connector jack that supports downstream linking of the device's expression signals, and multi-effects units do not provide alternate expression signal mapping nor to link to more than one control parameter at a time. Furthermore, graphical user interfaces are difficult to use. Access to the controls is buried under several layers of user interface screens. This places additional burden on the artist to remember the sequence of steps to get to the correct screen to access the desired controls. The practicality of accessing these controls in a live or real-time situation is quite limited.

At the present time, neither single-effect pedals, multi-effects floor processors, nor rackmount processors include the expression signal output that allows the expression pedal signal to be shared with downstream devices by connecting them in serial fashion with other devices in the effects chain. Furthermore there are no known devices that provide the ability to change the mapping of the expression signal to other control signals, such as inversely proportional, logarithmically proportional, inverse logarithmically proportional, square wave, ramp wave, sine wave, etc.

### SUMMARY

In accordance with one embodiment a device and method for providing an audio signal-processing device with ability to map multiple expression signal profiles to the expression signal and the capability to share the expression signal with adjacently connected audio signal-processing devices.

More specifically a device in accordance with the teachings of this invention relates to audio signal-processing devices that can be equipped with expression inputs for the purpose of manipulating the audio signal-processing devices' various control parameters. Such a device provides audio signal-processing devices with the ability to map alternate expression signal profiles to the control parameters, map each expression profile individually, and to share these expression control signals with downstream audio signal-processing devices connected together in serial fashion.

### Advantages

Accordingly several advantages of one or more aspects are as follows: ability to provide expression control over any combination of control parameters, ability to map alternate expression signals to control parameters, ability to assign expression signals to control parameters independently; ability to share the expression signal with downstream devices, the practical ability to make changes during live performances. Other advantages of one or more aspects will be apparent from a consideration of the drawings and ensuing descriptions.

### DRAWINGS

### Figures

In the drawings, closely related figures have the same number but different alphabetic suffixes.

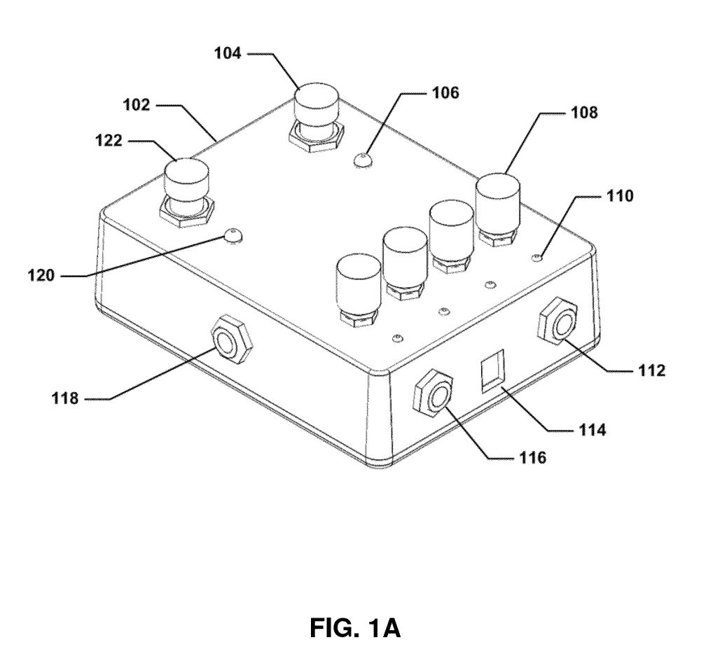

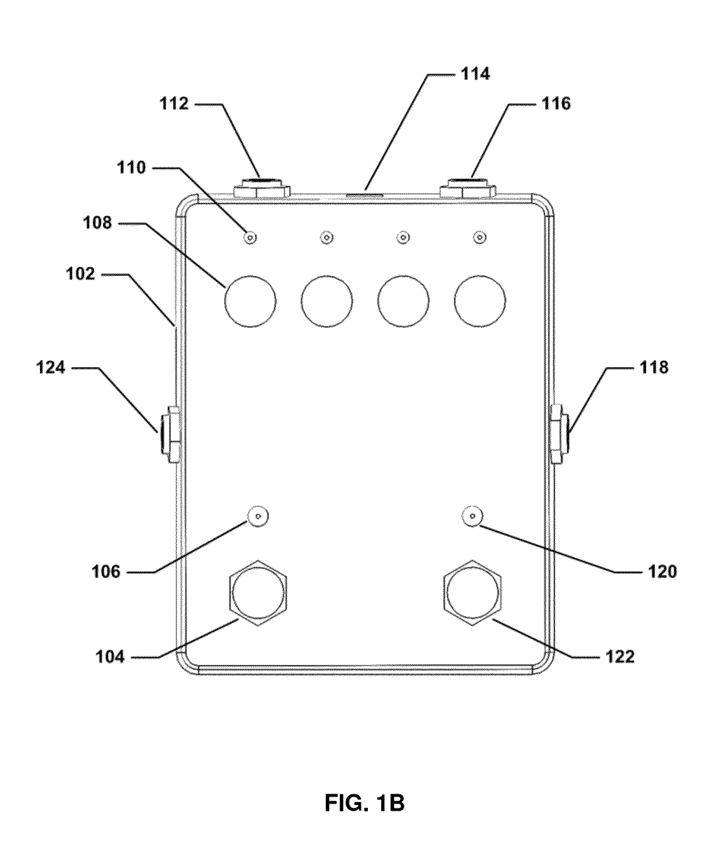

FIG. 1A is rear right hand perspective view of the proposed invention.

FIG. 1B is a top view of the proposed invention.

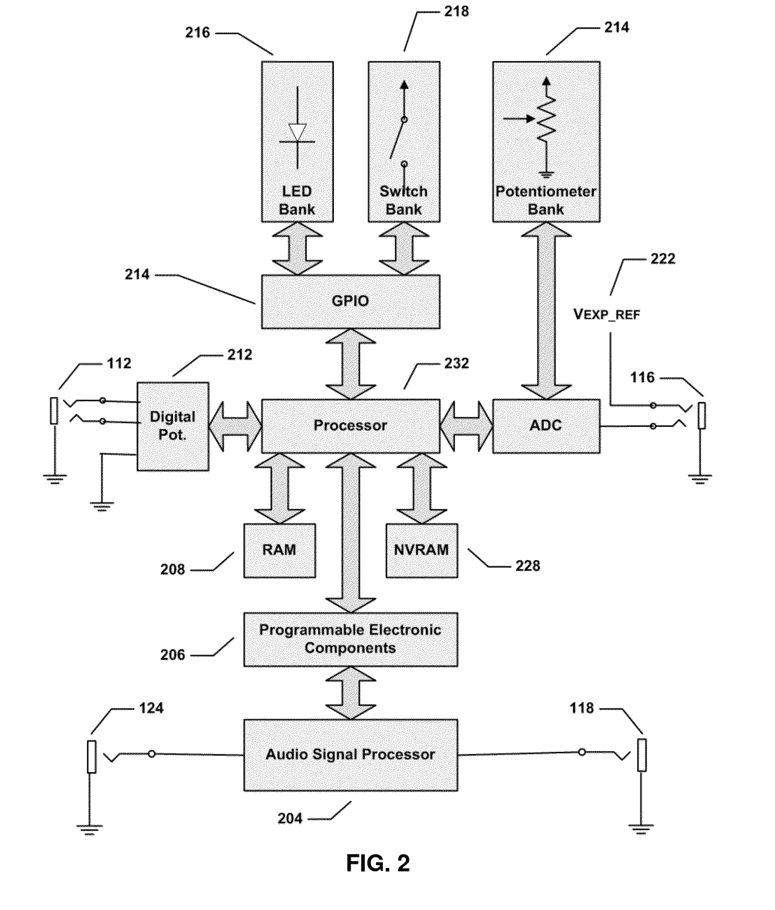

FIG. 2 is a block diagram representing the basic components and interconnections of the proposed invention.

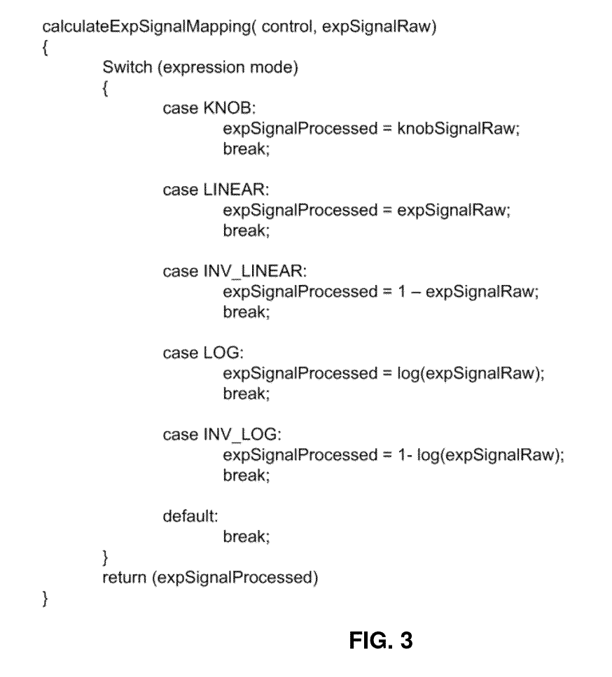

FIG. 3 illustrates pseudo code of the method of calculating alternate expression signal profiles.

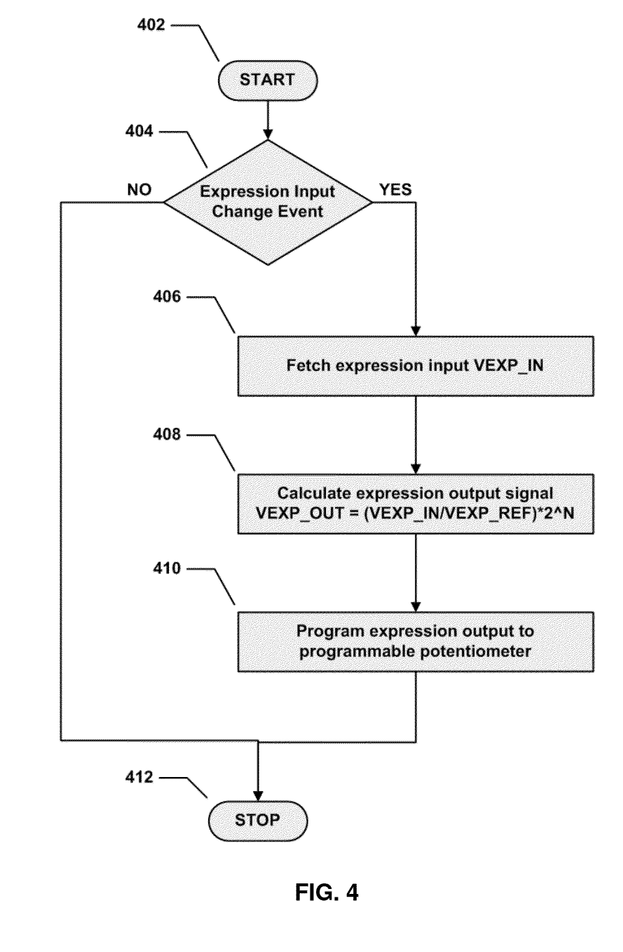

FIG. 4 illustrates a flowchart for programming the expression signal output.

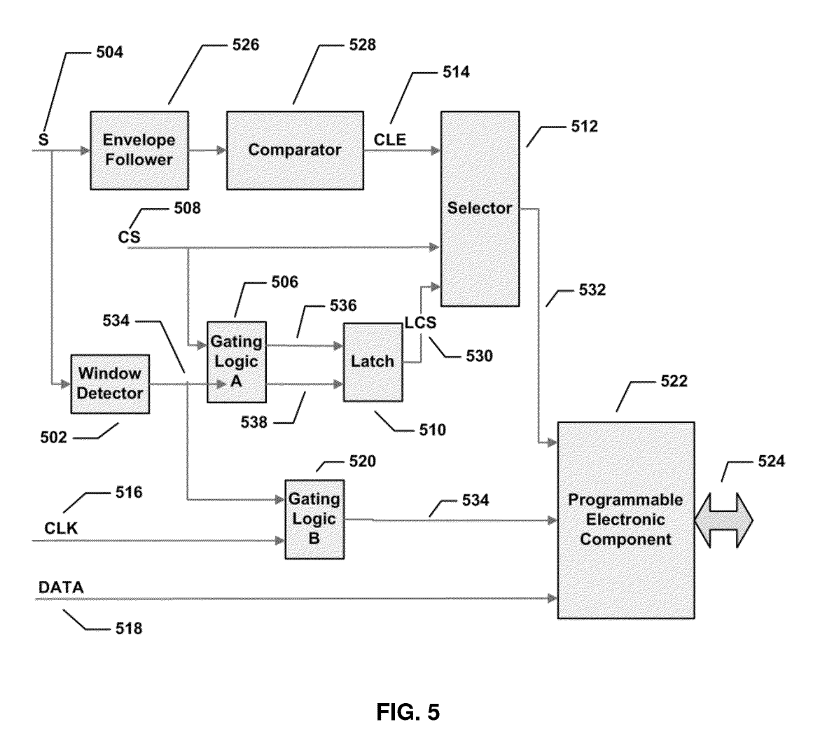

FIG. 5 illustrates a use of an embodiment of the present invention, in a simple setup, as it would be used by a guitarist employing a single audio signal-processing device and single expression pedal.

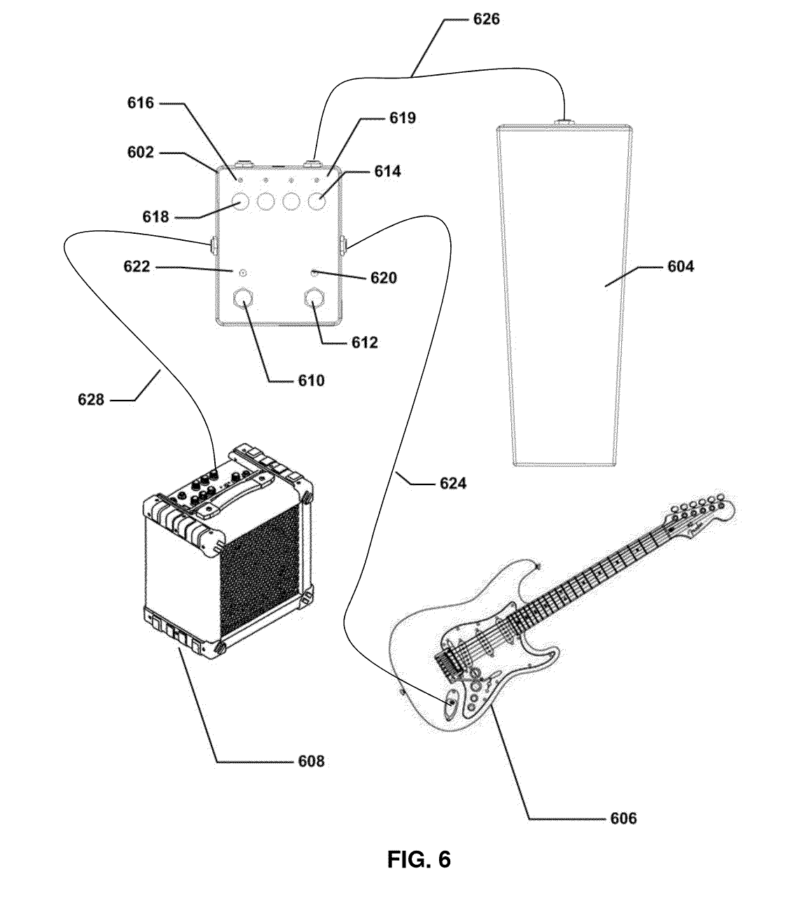

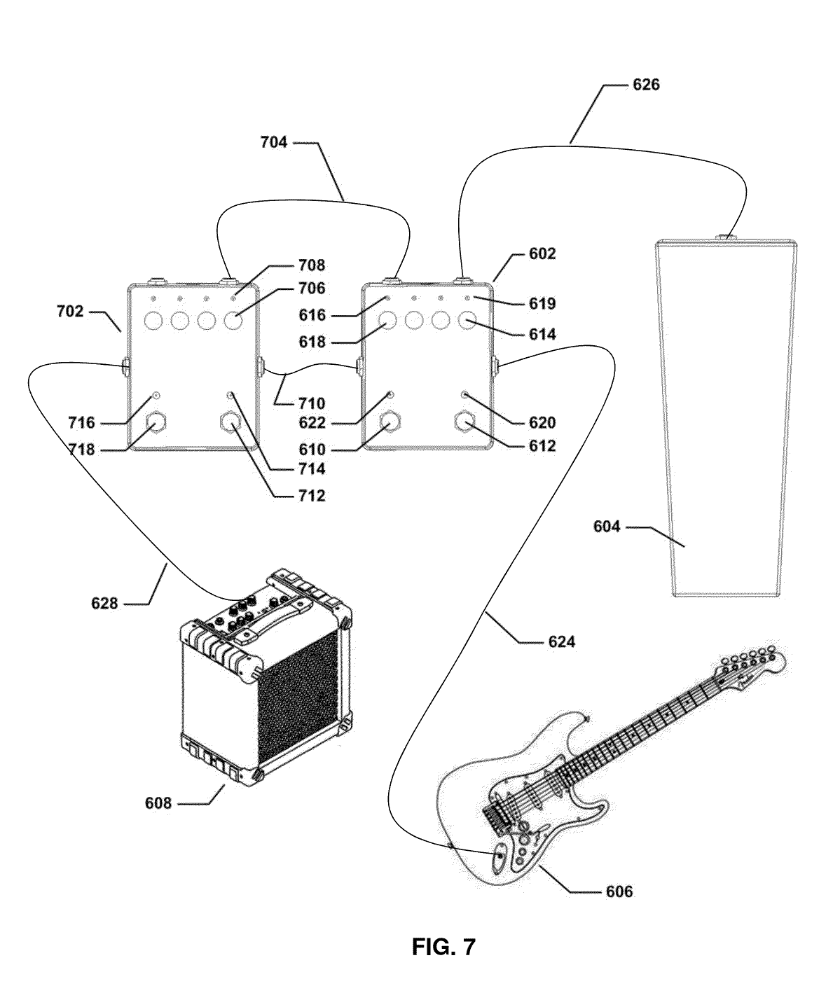

FIG. 6 illustrates a use of an embodiment of the present invention, in a more complex setup, as it would be used by a guitarist employing two audio signal-processing devices and a single expression device.

### DETAILED DESCRIPTION OF PREFERRED EMBODIMENTS

### FIGS. 1A-B—First Embodiment

One embodiment of our audio signal-processing device is illustrated in FIG. 1A (right rear perspective view), and FIG. 1B (top view). Our audio signal-processing device comprises:
One portable housing unit 102
An input power jack 114 for the purpose of accepting power from an external source
A processor 232 for the purpose of reading analog to digital converters, computing alternate expression profiles, sending control signals to programmable resistors, turning on and off indicators, and reading switches.
An input jack 118 for the purpose of coupling an instrument to the audio processing device
An output jack 124 for the purpose of coupling the audio processing device outputs to another audio processing device, such as an effects pedal or an amplifier
A Jack 116 to allow the coupling the audio signal-processing device to upstream effects pedals and expression devices, for the purpose of transmitting a reference expression signal and for receiving the returned expression signal
A jack 112 to allow the coupling of the audio signal-processing device to the downstream effects pedals for the purpose of receiving reference expression control signals from those downstream devices and for transmitting the expression control signal derived from the expression signal received on jack 116.
Electronic controls 108 that permit configuration of audio processing parameters such as volume, gain, filters, level, etc.
Electronic indicators 110 such as LEDs or incandescent lights, for each audio processing parameter and indicating the mapping of parameter to an expression control.
Foot operated switch 122 for enabling and disabling the effect of the audio processing device
Electronic indicator 120 such as LED or incandescent light, for indicating the state of the above foot switch 122.
Foot operated switch 104 for enabling or disabling external expression control
Electronic indicator 106 such as LED or incandescent light, for indicating the state of the above foot switch 104.

FIG. 1A is rear right hand perspective view in one orientation. In this view can be seen: the base enclosure 102; footswitch 122 to enable the audio signal-processing function; LED indicator 120 to indicate the actuation state of the audio signal-processing function footswitch 122; footswitch 104 to actuate the expression pedal processing; LED indicator 106 to indicate the actuation state of the expression pedal processing footswitch 104, rotary controls 108 for sound processing parameters: LED indicators 110 to indicate mapping of expression pedal input; instrument input jack 118; expression pedal inputjack 116; expression pedal signal forwardingjack 112; power inputjack 114.

FIG. 1B is a top view. In this view can be seen: the base enclosure 102; footswitch 122 to enable the audio signal-processing function: LED indicator 120 to indicate the actuation state of the sound processing function footswitch 122; footswitch 104 to actuate the expression pedal processing; LED indicator 106 to Indicate the actuation state of the expression pedal processing footswitch 104; rotary controls 108 for sound processing parameters; LED indicators 110 to indicate mapping of expression pedal input instrument input jack 114; amplifier output jack 124; expression pedal input jack 116; expression pedal signal output jack 112; power input jack 114.

It should be appreciated that FIGS. 1A through 1B represent but a single example of the proposed portable housing unit and that many other variations in size, shape, and control combinations are possible

### Operation—FIGS. 2, 3, 4

In the following section the operation of the device will be described with reference to FIG. 2 (block diagram illustrating major components and interconnections), FIG. 3 (pseudo code illustrating method of applying alternate expression signals, and FIG. 4 (flow chart illustrating means of calculating the expression signal output), FIG. [ ]

FIG. 2 is a block diagram representing the basic components and interconnections of the device. Processor 232 runs the machine instructions that determine the behavior of the device. Instructions are fetched from FLASH memory 208. Temporary variables are stored in RAM 230. Various configuration settings that must be stored when the unit is powered down are stored in Non Volatile RAM 228.

Processor 232 sends commands to general purpose I/O (GPIO) 214 to turn off and on a plurality of visual indicators in LED bank 216, and to read the state of a plurality of digital switches in Switch Bank 218.

Processor 232 sends commands to ADC 226 to Initiate analog to digital conversion of a plurality of analog signals. These analog signals originate from Potentiometer Bank 220 and from the Expression Input jack 116. Potentiometer Bank 220 includes a plurality of potentiometers that correspond to various control parameters for the desired audio processing performed in Audio Signal Processor 204. One terminal of each potentiometer is connected to a positive voltage and the opposite terminal is connected to a reference voltage. The output from the wiper is directed to one of the input channels on ADC 226.

An expression reference voltage is supplied to ring conductor of three-conductor jack 116. The signal from jack 116 is directed to an external expression pedal and the expression signal is returned on the tip of three-conductor jack 116. This expression signal is fed to one of the input channels of ADC 226 and is read by the Processor 232. Processor 232 computes a resistance value that is proportional to the expression signal received on jack 116 and programs digital potentiometer 212 accordingly.

Expression reference signals from downstream devices are directed to the ring of three conductor input jack 112 This downstream expression reference signal is directed to one terminal of Digital Potentiometer 212. The opposite terminal of Digital Potentiometer 212 is connected to ground. The wiper of the digital potentiometer 212 is directed to tip of three-conductor jack 112 where the expression signal is made available to downstream devices.

Digital Potentiometer 212 is programmed by Processor 232

According to the above description the device is able to link to upstream devices and create an expression signal for downstream devices.

The audio input signal arrives on two conductor input jack 118. This signal is directed to the Audio Signal Processor 204 where it is processed into the desired signal. Digital Potentiometers 206 control various aspects of the processing. The processed signal is directed to two-conductor jack 124 where it is made available to downstream devices.

FIG. 5 illustrates a use of the first embodiment in a simple setup using one audio signal-processing device and one expression pedal. The audio signal from the guitar 506 is directed to the input of audio signal-processing device 502. The audio signal output from the audio signal processing device 502 is directed to the amplifier 508. The expression reference signal from the audio signal-processing device 502 is directed to the expression pedal 504 on a cable and the expression signal is returned on the same cable. The expression return signal is processed by the audio signal-processing device 502. At this time it is determined to which control parameters the signal is mapped and to which expression signal profile it is mapped.

FIG. 6 illustrates a use of an embodiment of the present invention in a more complex setup employing two audio signal-processing devices and one expression pedal. The audio signal from the guitar 506 is directed to the first audio signal-processing device 502. The output of the first audio signal-processing device 502 is directed to the input of the second audio signal-processing device 602. The output from the second audio signal-processing device 602 is directed to the amplifier 508. The expression reference signal from the first audio signal-processing device 502 is directed to the expression pedal 504 and the resulting expression signal is returned to the first audio signal processing device 502 on the same cable. The expression reference signal from the second audio signal-processing device 602 is directed to the expression signal output of the first audio signal-processing device 502 and the resulting expression signal is returned to the second audio signal-processing device 602 on the same cable. Each audio signal-processing device now has an expression signal that is proportional to the rotation of the expression pedal 504. Each audio signal-processing device can map the expression signal to its control parameters independently of the other audio signal-processing device.

### ALTERNATIVE EMBODIMENTS

There are various possibilities with regard to the choice of signal-processing method implemented by audio signal-processor 204. In the various embodiments it may be completely analog, or completely digital, or a hybrid that is partially analog and partially digital.

There are various possibilities with regard to the method of implementation. In the various embodiments it may be as a standalone device, such as an effects pedal, while in other embodiments it may be integrated as part of a larger system, such as in an amplifier.

There are various possibilities with regard to the level of integration of the various components. In the various embodiments the device may be all-in-one where the audio signal processor and the rest of the system are implemented on a single board, while in other embodiments the audio signal processor is a separate device that connects to the rest of the system through a standardized interface and is therefore inter-changeable with other audio signal-processors sharing the same interface.

There are various possibilities with regard to the type of processor employed. In the various embodiments if may be a general purpose microprocessor, embedded processor, micro-controller, audio signal processor, or a digital signal processor.

There are various possibilities with regard to the arrangement of FLASH, RAM, NVRAM, ADC, and GPIO. Any one or more of these items may be included in the processor as in, for example, an embedded microprocessor or microcontroller.

### Advantages

From the description above, a number of advantages of some embodiments of our expression-enabled audio signal-processing device become evident:
Removes the need for the user to manipulate tone controls by hand during play
In general the device removes limitations on the way artists are able to express themselves.
provides the artist with a greater degree of personal expression
control over the music they are creating.
provides a more intuitive user interface.
The ability to map a single expression signal to a single audio processing parameter on a single audio processing device
The ability to map a plurality of expression signals to a plurality of audio processing parameters on a single audio processing device
The ability to use a single expression signal to control a plurality of audio processing parameters across a plurality of audio processing devices
The ability to map an expression signal to a plurality of expression profiles such as linear mapping, inverse linear mapping, logarithmic mapping, inverse logarithmic mapping, etc.
The ability to use a combination of expression signal mappings to control a plurality of audio processing parameters across a plurality of audio processing devices.
Minimizes the number of expression pedals, and thereby complexity and floor space, required if an expression pedal was connected to each individual pedal
Allows sharing of single expression signal generating device with multiple effects pedals
Removes the need for the expression pedal to be physically close to the effect pedal under control.
Removes the need to secure effects pedals to a mounting surface
Provides the ability to control any tone control on an individual effects pedal with a single expression device
provides the ability to control any combination of tone controls simultaneously on an individual effects pedal with a single expression device
provides the ability to control any combination of tone controls simultaneously on separate effects pedals with a single expression device
provides the ability to simultaneously fade some tone controls out and other tone controls in with a single expression device

### CONCLUSIONS, RAMIFICATIONS, AND SCOPE

Accordingly, the reader will see that the expression-enabled audio signal-processing device can be used to conveniently map alternate expression signal profiles to the input expression signal, and share expression control signals with other audio signal-processing devices.

In the following section a brief description will be provided of some of the various types of effects pedals to which the present invention may be applied.

A distortion pedal is an audio processing device that distorts the input signal in a way that is pleasing to the ear. The purpose of the device is to replicate the distortion created by various equipment such as tube amplifiers and over-driven speakers. A distortion pedal may include a number of controls such as Gain, Level, Bass, Mid, Treble, or any other controls as the device designer sees fit. Each of these controls is configured by the artist to define the desired tone. Our device can easily be applied to distortion pedals of any type. The expression signal can be mapped to any combination of the available controls and the expression output can easily be added to permit expression signal sharing.

A chorus pedal is an audio processing device that adds a slightly delayed version of the original signal back to itself along with a time modulation. The delay in this device typically ranges from 20 to 30 milliseconds. This produces the illusion of two artists playing synchronized and corresponding notes. A chorus pedal may include a number of controls such as, Depth/Mix, Delay, Sweep Depth, LFO Waveform, Speed/Rate, Number of Voices, or any other controls as the device designer sees fit. Each of these controls is configured by the artist to define the desired tone. Our device can easily be applied to chorus pedals of any type. The expression signal can be mapped to any combination of the available controls and the expression output can easily be added to permit expression signal sharing.

A delay pedal is an audio processing device that outputs the original input signal and adds to it a delayed copy of itself. The delay in this device typically ranges from few hundred milliseconds to several seconds. There are various types of delays such as Slap-back (a very short delay), multi-tap (longer delay with multiple echoes) and ping-pong (bounces back and forth between left and right channels). A delay pedal will typically include a number of controls such as Depth, Delay, and Feedback/Regeneration, or any other controls as the device designer sees fit. Each of these controls is configured by the artist to define the desired tone. Our device can easily be applied to delay pedals of any type. The expression signal can be mapped to any combination of the available controls and the expression output can easily be added to permit expression signal sharing.

A phaser is an audio processing device that mixes a phase shifted version of an audio signal with the original version. A local frequency oscilliator is typically used to sweep the phase shift back and forth through a range. The resulting interference between the two signals causes various frequencies to be cancelled out producing a characteristic sound. A phaser pedal will typically include a number of controls such as Depth/Mix, Sweep Depth, Feedback/Regeneration, Speed/Rate, or any other controls as the device designer sees fit. Each of these controls is configured by the artist to define the desired sound. Our device can easily be applied to Phaser pedals of any type. The expression signal can be mapped to any combination of the available controls and the expression output can easily be added to permit expression signal sharing.

A flanger is an audio signal-processing device that mixes the original signal with a slightly delayed copy, and where the delay is constantly sweeping between some minimum and maximum values, usually between 1 and 10 milliseconds. The controls on such a device typically include Depth/Mix, Delay, Sweep Depth, LFO Waveform, Feedback/Regeneration, and Speed/Rate, or any other controls as the device designer sees fit. Each of these controls is configured by the artist to define the desired tone. Our device can easily be applied to flanger pedals of any type. The expression signal can be mapped to any combination of the available controls and the expression output can easily be added to permit expression signal sharing.

An equalizer is an audio signal-processing device whose main purpose is to amplify or attenuate the various frequency bands independently. The audio spectrum may be divided up into an arbitrary number of bands each with its own control parameter. Our device can easily be applied to equalizers of any type. The expression signal can be mapped to any combination of the available controls and the expression output can easily be added to permit expression signal sharing.

An amplifier is an audio signal-processing device whose main purpose is to amplify the original audio signal and drive a loud speaker. Amplifiers also include control parameters for shaping the tone of the audio signal. The control parameters typically include volume, gain, bass, mid, and treble. They may also include control parameters for various built-in effects such as, but are not limited to, reverb, tremolo, distortion, chorus, phaser, and flanger. Our device can easily be applied to an amplifier of any type. The expression signal can be mapped to any combination of the available controls and the expression output can easily be added to permit expression signal sharing.

It should be appreciated that the above examples are merely representative of the types of audio signal-processing devices that can make use of the proposed invention and that many more possibilities, exist.

To better appreciate the full impact of our device several practical examples are now provided. Each example includes the equipment setup and describes how the artist might use the setup during the performance of a song.

As one example of an application of our device consider FIG. 5. In this Figure there is a simple setup involving a single effects pedal equipped with the present invention and a single expression pedal. Let us assume for the purpose of this example that the device 502 is a distortion pedal and that that the song requires the following variations in order: 1) clean signal, 2) signal with effects as controlled by control knobs on the user interface. 3) signal with effects as controlled by the expression pedal using a linear mapping on gain control 518 and an inverse logarithmic mapping on tone control 514, and 4) a clean signal

Prior to performing the artist would set up the equipment. First guitar 506 is plugged into effect device 502 via cable 524. Next the expression pedal 504 is connected to effect device 502 via cable 526. Then effect device 502 is connected to amplifier 508 via cable 528. For the clean signals of variations 1 and 4 no setup is required. To setup for variation 2) the knobs would be rotated to the desired position as determined by the artist's experience with the equipment. To setup for variation 3) gain control 518 is depressed until LED 516 is the color corresponding to a linear mapping and tone control 514 is depressed a number of times until LED 519 is the color corresponding to an inverse logarithmic mapping.

To begin the performance both footswitches 510 and 512 are not activated. At this time the sound is unprocessed or “dean” and the artist may play. At the desired time the artist activates variation 2) by depressing footswitch 512 until LED 520 turns on. At this time the signal is processed in accordance with the control knobs and the expression pedal is ignored. At a later desired time the artist may enable the expression pedal by pressing footswitch 510 until LED 522 turn on. The expression pedal can then be rotated to affect the sound. As the expression pedal is rotated the distortion level is increased and the tone is decreased. Finally the artist returns to a clean signal by depressing footswitch 512.

As yet another example of an application of our device consider FIG. 6. In this figure a more advanced application, involving two effects pedals equipped with the present invention is described. Let us assume for the purposes of this example that pedal 502 is a distortion pedal and pedal 602 is a chorus pedal and let us further assume that the song requires the following variations in order: 1) clean signal, 2) signal with distortion, 3) signal with chorus, 4) signal with distortion, Level controlled by expression pedal, 5) signal with chorus, Sweep controlled by expression pedal, 6) signal with distortion, Level controlled by linear mapping to expression pedal and chorus, Sweep controlled by inverse linear mapping to expression pedal.

Prior to performing the artist would set up the equipment. First guitar 506 is connected to input of distortion pedal 502 via cable 524. Then expression in of distortion pedal 502 is connected to expression pedal 504 via cable 526. Distortion pedal expression out is connected to chorus pedal (602) expression input via cable 604. Distortion pedal 502 amplifier output is connected to chorus pedal 602 instrument input via cable 610. Chorus pedal 602 amplifier output is connected to the amplifier 508 via cable 528. For variation 1) the clean signal no setup is required. To setup for variation 2) the knobs of the distortion pedal 502 would be rotated to the desired position as determined by the artist's experience with that equipment. To setup for variation 3) the knobs of the chorus pedal 602 would be rotated to the desired position as determined by the artist's experience with that equipment. To setup for variation 4) the distortion pedal 502 Gain control 518 is depressed until LED 516 is the color corresponding to a linear mapping. To setup for variation 5) the chorus pedal Sweep control 606 is depressed until LED 608 is the color corresponding to an inverse linear mapping to the expression pedal.

To begin the performance switches 512, 510, 612, and 618 are all off The artist can begin to play in variation 1. To proceed to variation 2 the artist would depress distortion effect switch 512 until LED 520 turns on. To proceed with variation 3 the artist would depress distortion effect switch 512 until LED 520 turns off and then depress chorus effect switch 612 until LED 614 turns on. To proceed to variation 4 the artist would depress chorus effect switch 612 until LED 614 turns off, then depress distortion effect switch 512 until LED 520 turns on and depress distortion expression switch 510 until LED 522 turns on. At this time the expression pedal 504 may be used to control the distortion pedal 502 gain parameter. To proceed to variation 5 the artist would depress distortion effect switch 512 until LED 520 turns off, depress chorus effect switch 612 until LED 614 turns on, depress chorus expression switch 618 until LED 616 turns on. At this point the artist will be able to control the chorus pedal 602 sweep parameter with the expression pedal. To proceed to variation 6 the artist would depress distortion effect switch 512 until LED 520 turns on. Since distortion expression switch 510 was left in the on state the artist is now ready to simultaneously control the chorus pedal 602 sweep control and the distortion pedal 502 gain control with the same expression pedal movements.

Although the description above contains many specificities these should not be construed as limiting the scope of the embodiments but as merely providing illustrations of some of several embodiments. For example, the audio signal-processing device can be implemented using digital processing, analog processing, or some combination of digital and analog processing; the controls can be, but are not limited to, variable resistors, variable capacitors, variable inductors, rotary encoders or linear encoders.

Thus the scope of the embodiments should be determined by the appended claims and their legal equivalents, rather than by the examples given.

1. An audio signal processing device for a musical instrument, comprising multiple expression inputs to manipulate the control parameters thereof.

2. The audio signal processing device of claim 1, constructed and arranged to permit expression pedal signals to be shared with downstream devices.

3. The audio signal processing devices of claim 1, constructed and arranged to permit mapping of multiple expression signal profiles to the expression signal.

4. The audio signal processing device of claim 1, comprising:
a portable housing unit;
an Input power jack for accepting power from an external source;
a processor for reading analog to digital converters, computing alternate expression profiles, sending control signals to programmable resistors, turning on and off indicators, and reading switches;
an input jack for coupling an instrument to the audio processing device;
an output jack for coupling the audio processing device outputs to another audio processing device;
an upstream jack for transmitting a reference expression signal and for receiving the returned expression signal;
an upstream jack for receiving reference expression control signals from those downstream devices and for replicating the expression control signal received on jack; and
electronic controls for controlling audio processing parameters.

5. The audio signal processing device of claim 4, wherein the processor sends commands to the ADC to initiate analog to digital conversion of a plurality of analog signals, wherein the analog signals originate from a potentiometer bank and from an expression input jack.

6. The audio signal processing device of claim 5, wherein the potentiometer bank includes a plurality of potentiometers that correspond to various control parameters for the desired audio processing performed in Audio Signal Processor 204.
